(19) United States
(12) Patent Application Publication
(10) Pub. No.: US 2013/0033992 A1
(43) Pub. Date: Feb. 7, 2013

(54) RADIO BASE STATION APPARATUS AND SCHEDULING METHOD

(71) Applicant: Kenichi Higuchi, Tokyo (JP)

(72) Inventor: Kenichi Higuchi, Tokyo (JP)

(73) Assignee: NTT DOCOMO, INC., Tokyo (JP)

(21) Appl. No.: 13/580,157

(22) PCT Filed: Feb. 23, 2011
(86) PCT No.: PCT/JP2011/054038

§ 371 Date: Oct. 23, 2012

(30) Foreign Application Priority Data
Feb. 25, 2010 (JP) 2010-040304

(51) Int. Cl. H04W 72/04; H04W 24/00; H04B 17/02

(52) U.S. Cl. 370/246

(57) ABSTRACT

The present invention provides a radio base station apparatus and a scheduling method that can improve user throughput performance in an adaptive AF-type relay transmission method. The scheduling method according to the present invention includes the steps of receiving a signal including a reference signal, measuring an instantaneous channel gain by path loss and fading, among a mobile terminal apparatus, a radio relay station apparatus and a radio base station apparatus, with respect to an uplink, using the reference signal; and performing downlink resource allocation based on the instantaneous channel gain by path loss and fading.

### TECHNICAL FIELD

The present invention relates to a radio base station apparatus and a scheduling method to perform adaptive AF (Amplify-and-Forward)-type relay transmission.

### BACKGROUND ART

The fourth generation mobile communication system, referred to as IMT-Advanced (International Mobile Telecommunications-Advanced) in the ITU-R (International Telecommunication Union-Radio Communication Sector), is required to support very high data rates, compared to the present third generation mobile communication system. To realize such high data rates, particularly, reduction of coverage, resulting from the limitation of transmission power in transmission from a mobile terminal apparatus, poses a technical problem.

In recent years, relay transmission is gaining popularity as a technique for realizing high speed radio transmission in a wide coverage in a power-limited environment. Relay transmission can be generally categorized into the AF (Amplify-and-Forward) type, which amplifies and forwards a received RF (Radio Frequency) signal, without demodulation, and the DF (Decode-and-Forward) type, which, in a radio relay station apparatus, demodulates and decodes a received signal to be relayed, on a temporary basis, and re-encodes and re-modulates the detected data to forward.

Although AF-type relay transmission has an advantage of making the transmission delay time required for relay forwarding little, there is a problem that, in a radio relay station apparatus, noise and interference components contained in a received signal are amplified and forwarded with the desired signal component, and therefore, in cellular communication, inter-cell interference increases. Also, generally, in relay transmission, frequency usage efficiency deteriorates due to the need to allocate part of the communication band to relay signals.

So, the present inventor has first proposed an adaptive AF-type relay transmission method to control whether or not to apply relay transmission, in two steps, based on the magnitude of path loss between a mobile terminal apparatus and a radio base station apparatus, and between a mobile terminal apparatus and each radio relay station apparatus, and to control which radio relay station apparatus to use when performing relay transmission (non-patent literature 1 and patent literature 1).

### CITATION LIST

### Patent Literature

Patent Literature 1: Japanese Patent Application Laid-Open No. 2009-177628

### Non-Patent Literature

Non-Patent Literature 1: Haruaki Machida and Kenichi Higuchi, “Investigation of Transmission Power Control in Adaptive Amplify-and-Forward Relaying for Cellular System,” Proceedings of the 2008 IEICE General Conference, B-5-92, March 2008.

### SUMMARY OF INVENTION

### Technical Problem

In this adaptive AF-type relay transmission method, relay transmission to a mobile terminal apparatus near a radio base station apparatus is made OFF, and, even when relay transmission is performed, only a radio relay station apparatus that is located at a short distance from a mobile terminal apparatus is made ON, thereby alleviating the problems of undesirable deterioration of frequency usage efficiency and increased other-cell interference due to relay transmission. In this adaptive AF-type relay transmission method, user throughput performance relies heavily on the amount of inter-cell interference.

The present invention has been made in view of the above problems, and it is therefore an object of the present invention to provide a radio base station apparatus and a scheduling method which can improve user throughput performance in an adaptive AF-type relay transmission method.

### Solution to Problem

A radio base station apparatus according to the present invention includes a receiving section that receives a signal including a reference signal, a channel state measurement section that measures an instantaneous channel gain by path loss and fading, among a mobile terminal apparatus, a radio relay station apparatus and a radio base station apparatus, with respect to an uplink, using the reference signal, and a scheduling section that performs downlink resource allocation based on the instantaneous channel gain by path loss and fading.

A scheduling method according to the present invention includes the steps of receiving a signal including a reference signal, measuring an instantaneous channel gain by path loss and fading, among a mobile terminal apparatus, a radio relay station apparatus and a radio base station apparatus, with respect to an uplink, using the reference signal, and performing downlink resource allocation based on the instantaneous channel gain by path loss and fading.

### Technical Advantages of Invention

According to the present invention, it is possible to improve user throughput performance in an adaptive AF-type relay transmission method.

### BRIEF DESCRIPTION OF DRAWINGS

FIG. 1 is a diagram for explaining adaptive AF-type relay transmission;

FIG. 2 is a diagram for explaining adaptive AF-type relay transmission;

FIG. 3 is a diagram illustrating a configuration of a radio relay station apparatus according to an embodiment of the present invention;

FIG. 4 is a diagram illustrating a configuration of a radio base station apparatus according to an embodiment of the present invention; and

FIG. 5 is a diagram illustrating cumulative distribution of user throughput.

### DESCRIPTION OF EMBODIMENTS

Now, embodiments of the present invention will be described below in detail with reference to the accompanying drawings. The adaptive AF-type relay transmission method, which provides basis of scheduling according to the present invention, will be described. Adaptive AF-type relay transmission in a cellular environment, which the present inventor has first proposed, alleviates the problems of amplification of other-cell interference in conventional AF-type relay transmission (repeater) and loss of the efficiency of use of allocated time/frequency resources accompanying relay transmission.

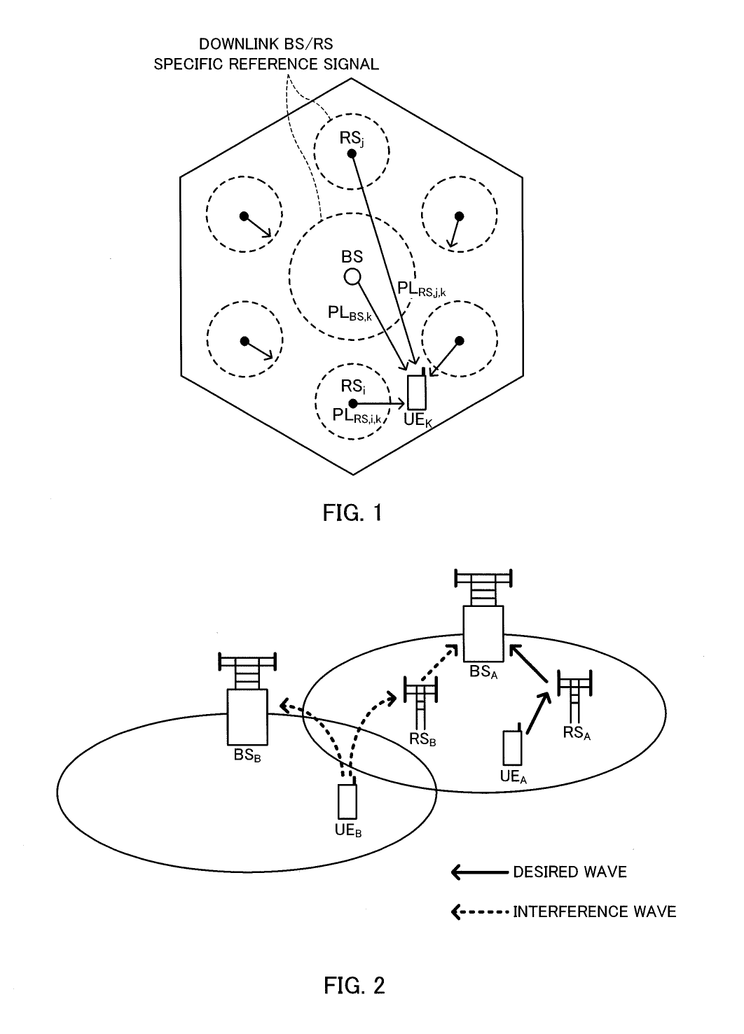

As illustrated in FIG. 1, in addition to a radio base station apparatus (BS), each radio relay station apparatus i (i=1, 2, . . . , N_{RS}: N_{RS} is the number of radio relay station apparatuses in the cell) transmits a unique downlink reference signal (downlink BS/RS-specific reference signal: pilot channel signal). A mobile terminal apparatus UEₖ measures the amount of path loss (distance attenuation+shadowing) PL_{BS,k} and PL_{RS,i,k} between a radio base station apparatus and each radio relay station apparatus using the reference signals. The mobile terminal apparatus UEₖ reports PL_{BS,k} and PL_{RS,i,k} to the radio base station apparatus periodically. The radio base station apparatus selects a radio relay station apparatus to use for transmission for the mobile terminal apparatus UEₖ using PL_{BS,k} and PL_{RS,i,k} adaptively, in two steps.

In the first step, the radio base station apparatus selects whether or not to perform relay transmission for the mobile terminal apparatus UEₖ based on PL_{BS,k}. To be more specific, relay transmission is performed only when PL_{BS,k} that is normalized by the amount of distance attenuation at the cell edge is greater than a threshold T that is determined in advance. For example, it is possible to make the threshold T=20 dB. On the other hand, when relay transmission is not performed, all the time/frequency resources allocated to the mobile terminal apparatus UEₖ are used for transmission by the mobile terminal apparatus. When relay transmission is performed, ½ of the allocated time is used for transmission by the radio relay station apparatus. In the event relay transmission is performed, further, in a second step, the radio relay station apparatus to use for relay transmission is selected.

In the second step, the radio base station apparatus selects the radio relay station apparatus to use for uplink transmission by the mobile terminal apparatus UEₖ, based on PL_{RS,i,k}. To be more specific, using a threshold Δ determined in advance, only a radio relay station apparatus i to satisfy following equation 2 is used.

[EQ. 1]

PL_{RS,i,k}≦min PL_{RS,j,k}+Δ in dB (Equation 2)

In the first step, by cancelling relay transmission for mobile terminal apparatuses near the cell, time/frequency resources are improved, and the amount of amplification of other-cell interference is reduced. Then, in the second step, the amplification factor for a radio relay station apparatus which contributes little to the increase of received power in the desired mobile terminal apparatus is made 0, so that the amount of amplification of other-cell interference is further reduced.

The radio base station apparatus reports the number of radio relay station apparatuses to use for the mobile terminal apparatus UEₖ to all radio relay station apparatuses, via a downlink control channel in advance. After that, the radio base station apparatus determines the allocation of uplink transmission for each mobile terminal apparatus, periodically, based on a scheduler, and reports this to each mobile terminal apparatus by a downlink control signal. This scheduling information is received by each radio relay station apparatus in the cell. In the event the mobile terminal apparatus doesn't perform relay transmission, all of the radio relay station apparatuses make the power amplification factor 0. Also, in the event the mobile terminal apparatus performs relay transmission, only a radio relay station apparatus that is selected in advance corresponding to the mobile terminal apparatus sets the power amplification factor greater than 0, and the other radio relay station apparatuses make the power amplification factor 0.

Next, scheduling in the adaptive AF-type relay transmission method according to the present invention will be described. In the following description, assume that the path loss between a mobile terminal apparatus and a radio base station apparatus is PL_{UE-BS}, the path loss between a mobile terminal apparatus and a radio relay station apparatus is PL_{US-RS}, and the path loss between a radio relay station apparatus and a radio base station apparatus is PL_{RS-BS} (each in dB value). Also, assume that the instantaneous channel gain of a frequency block (i) due to fading between a mobile terminal apparatus and a radio base station apparatus is F_{UE-BS (i)}, the instantaneous channel gain of a frequency block (i) due to fading between a mobile terminal apparatus and a radio relay station apparatus is F_{UE-RS (i)}, and the instantaneous channel gain of a frequency block (i) due to fading between a radio relay station apparatus and a radio base station apparatus is F_{RS-BS (i)}. Also, assume that the power amplification gain of a radio relay station apparatus is G.

Assume that time division multiplexing is used to multiplex a transmission signal of a mobile terminal apparatus and a relay signal of a radio relay station apparatus, and, when relay transmission is performed, in the first time slot, the mobile terminal apparatus transmits one radio packet, and, in a second time slot, the radio relay station apparatus forwards the transmission signal of the mobile terminal apparatus received in the first time slot, to a radio base station apparatus. On the other hand, when relay transmission is not performed, the mobile terminal apparatus transmits two radio packets using two time slots. Also, when relay transmission is not performed, the metric for scheduling for the frequency block i is M_{no relay}=F_{UE-BS(i)}.

With the scheduling method according to the present invention, instantaneous channel gain by path loss and fading among a mobile terminal apparatus, a radio relay station apparatus and a radio base station apparatus is measured with respect to the uplink, and downlink resource allocation is performed based on this instantaneous channel gain by path loss and fading. For the scheduling method present invention, the following three methods are possible.

(1) First Method

the first method, the metric of a frequency block i upon relay transmission is determined by the instantaneous channel gain of a link between a mobile terminal apparatus and a radio relay station apparatus (M_{relay}=F_{UE-RS(i)}). That is to say, in the first method, downlink resource allocation is performed based on the instantaneous channel gain by fading between a mobile terminal apparatus and a radio relay station apparatus.

Normally, a radio relay station apparatus is provided in a state to make the communication environment with a radio base station apparatus good. Consequently, the bottle neck in the channel state is likely to be a link between the radio relay station apparatus and a mobile terminal apparatus, not the link between the radio relay station apparatus and the radio base station apparatus. Consequently, with the first method, channel state of the link between a radio relay station apparatus and a mobile terminal apparatus is measured, and downlink resource allocation is performed from a link showing a good channel state (that is, a link of a great metric). Assume that, in the first method, the fading variation in two time slots, that is, the first time slot for transmission between a mobile terminal apparatus and a radio relay station apparatus, and a second time slot for transmission between the radio relay station apparatus and a radio base station apparatus, is assumed to be constant.

(Second Method)

In the second method, the metric of a frequency block i upon relay transmission is determined based on the instantaneous-to-average received signal power ratio in a radio base station apparatus in the event the same frequency block is used in two time slots. That is to say, in the second method, downlink resource allocation is performed based on the value of following equation 1.

$$\begin{matrix}[ EQ . 2 ] & \\ {M}_{relay} ( i ) = \frac{\begin{matrix}{F}_{UE - BS} ( i ) {PL}_{UE - BS} + \\ {F}_{RS - BS} ( i ) {PL}_{RS - BS} {GF}_{UE - RS} ( i ) {PL}_{UE - RS}\end{matrix}}{{PL}_{UE - BS} + {PL}_{RS - BS} {GL}_{UE - RS}} & ( Equation 1 )\end{matrix}$$

Consequently, with the second method, the channel state of links among a mobile terminal apparatus, a radio relay station apparatus and a mobile terminal apparatus is measured, and the metric is calculated by above equation 1, so that downlink resources are allocated from a link of a greater metric. In this case, also, the fading variation in two time slots, that is, the first time slot for transmission between a mobile terminal apparatus and a radio relay station apparatus, and a second time slot for transmission between the radio relay station apparatus and a radio base station apparatus, is assumed to be constant.

With the first method and second method above, the determined metric is used in common in two time slots (the first time slot and second time slot), so that it is possible to reduce the amount of calculation.

In the third method, the first time slot and second time slot are scheduled separately. That is to say, in the third method, in the first time slot, downlink resource allocation is performed based on the instantaneous channel gain by fading between a mobile terminal apparatus and a radio relay station apparatus, and, in a second time slot, downlink resource allocation is performed based on the instantaneous channel gain by fading between the radio relay station apparatus and a radio base station apparatus. Then, the metric of a frequency block i in the first time slot is based on F_{UE-RS(i)} (M_{relay}=F_{UE-RS(i)}), and the metric of the frequency block i in the second time slot is based on F_{RS-BS(i)} (M_{relay}=F_{RS-BS(i)}). With the third method, more efficient radio resource allocation is made possible.

FIG. 2 is a conceptual diagram of a relay transmission system. In this relay transmission system, a radio relay station apparatus (RS) is present in the cell, in addition to a radio base station apparatus (BS: eNB) and a mobile terminal apparatus (UE). In FIG. 2, a mobile terminal apparatus UE_{A} is present on a cell edge, and, when transmitting an uplink signal to the radio base station apparatus BS_{A} of the serving cell directly, might transmit the uplink signal by greater power than a mobile terminal apparatus near the radio base station apparatus BS_{A}. However, given that a radio relay station apparatus RS_{A} is present between that mobile terminal apparatus UE_{A} and the radio base station apparatus BS_{A}, an uplink signal from the mobile terminal apparatus UE_{A} is transmitted to the radio base station apparatus BS_{A} via the radio relay station apparatus RS_{A}.

Consequently, upon transmitting an uplink signal from the mobile terminal apparatus UE_{A} to the radio base station apparatus BS_{A} via the radio relay station apparatus RS_{A}, the mobile terminal apparatus UE_{A} can transmit that uplink signal by enough power to reach the radio relay station apparatus RS_{A} that is nearer than the radio base station apparatus BS_{A}, so that it is possible to lower the transmission power of the mobile terminal apparatus UE_{A}. Note that the radio relay station apparatus RS_{A} may be a mobile terminal apparatus or a fixed station in terms of the fundamental operations. Also, unlike a radio base station apparatus, the radio relay station apparatus has only to have functions for relaying signals, and therefore can be provided in a simpler manner and at lower cost than a radio base station apparatus. A relay transmission system is described in, for example A. Nostatinia, T. E. Hunter, and A. Hedayat, “Cooperative Communication in Wireless Networks,” IEEE Communications Magazine, Vol. 42, No. 10, pp. 74-80, October 2004, the entire content of which is incorporated herein by reference.

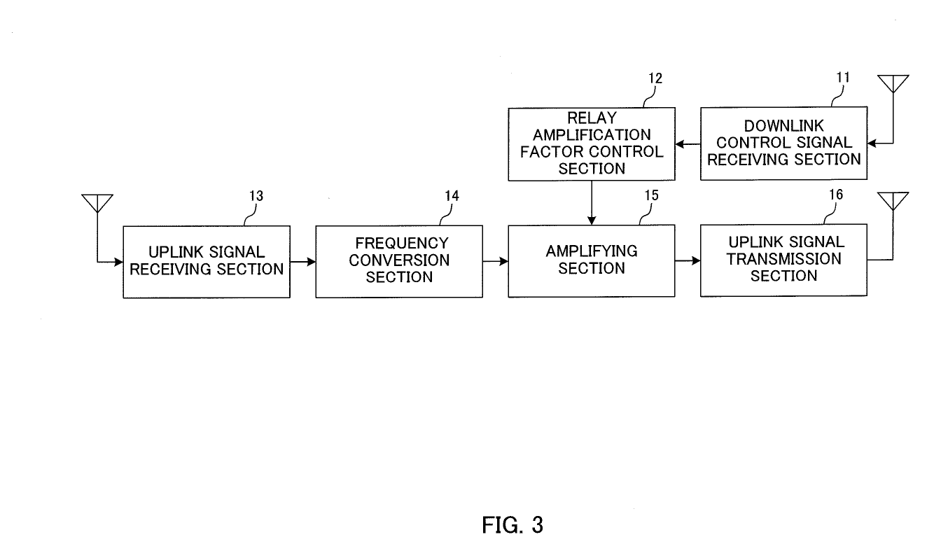

FIG. 3 is diagram illustrating a configuration of a radio relay station apparatus according to an embodiment of the present invention. The radio relay station apparatus illustrated in FIG. 3 is mainly formed with a downlink control signal receiving section 11 that receives a downlink control signal from a radio base station apparatus, a relay amplification factor control section 12 that controls the relay amplification factor of a signal to relay, an uplink signal receiving section that receives an uplink signal from a mobile terminal apparatus, a frequency conversion section 14 that, in the event the transmitting frequency and the receiving frequency are different, converts the frequency of a received signal into the frequency of a transmission signal, an amplifying section 15 that amplifies an uplink signal to relay in accordance with a relay amplification factor, and an uplink signal transmission section 16 that transmits an uplink signal to a radio base station apparatus.

The downlink control signal receiving section 11 receives a downlink control signal from a radio base station apparatus. This downlink control signal includes relay information which shows whether a mobile terminal apparatus performs relay transmission. Also, the downlink control signal includes uplink schedule information (resource allocation information). The downlink control signal receiving section 11 demodulates the downlink control signal and acquires the uplink scheduling information and relay information.

The relay amplification factor control section 12 controls the relay amplification factor upon relaying an uplink signal, based on the information acquired from the downlink control signal. That is to say, in the event relay information is information to show that relay transmission is performed, the relay amplification factor control section 12 controls the relay amplification factor upon relay transmission.

The relay amplification factor control section 12 outputs information about the relay amplification factor to the amplifying section 15. The amplifying section 15 amplifies an uplink signal subjected to frequency conversion in the frequency conversion section 14 (an uplink signal to be relayed), by the relay amplification factor received from the relay amplification factor control section 12.

The uplink signal receiving section 13 receives an uplink signal from the mobile terminal apparatus. The uplink signal receiving section 13 outputs the uplink signal to the frequency conversion section 14. The frequency conversion section 14 converts the frequency of the received signal into the frequency of a transmission signal. The frequency conversion section 14 outputs the uplink signal after frequency conversion, to the amplifying section 15.

Here, a case will be described where, when relaying is performed, the receiving frequency and the transmitting frequency are different in a radio relay station apparatus. In the event the same frequency is used for the receiving frequency and the transmitting frequency of a radio relay station apparatus and instead of this the time slots and/or codes are made different, the frequency conversion section 14 is not necessary.

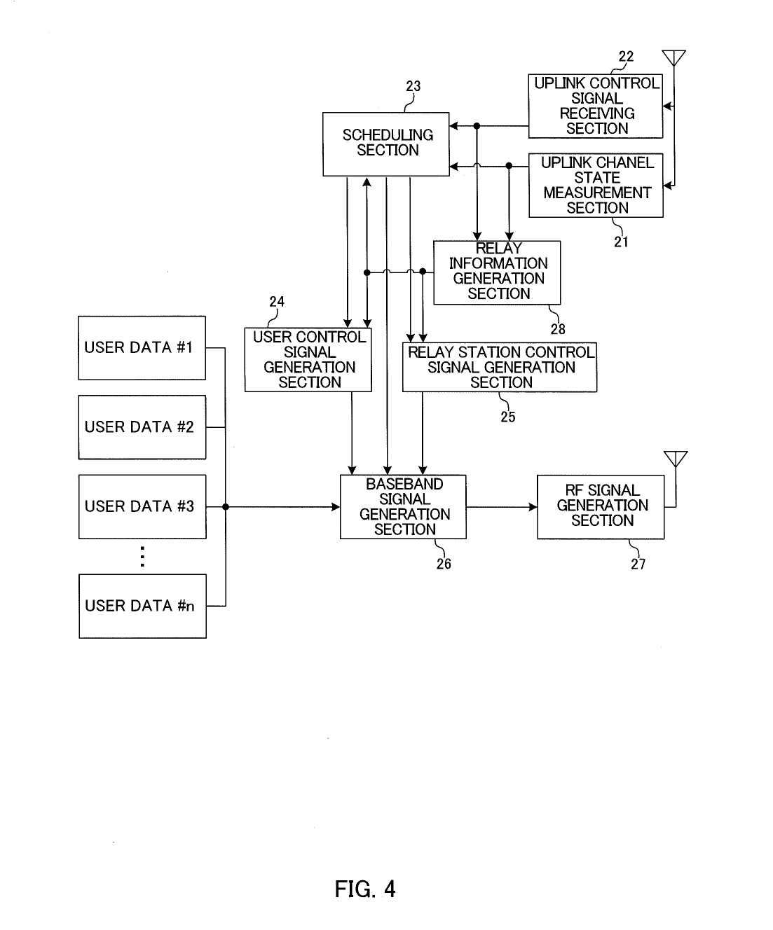

The uplink signal transmission section 16 transmits the uplink signal amplified by the relay amplification factor in the amplifying section 15, to the radio base station apparatus. That is to say, the uplink signal transmission section 16 transmits the uplink signal amplified by the controlled relay amplification factor, to the radio base station apparatus. FIG. 4 is a diagram illustrating a configuration of a radio base station apparatus according to an embodiment of the present invention. The radio base station apparatus illustrated in FIG. 4 is mainly formed with an uplink channel state measurement section 21 that measures an uplink channel state, an uplink control signal receiving section 22 that receives an uplink control signal from a mobile terminal apparatus, a scheduling section 23 that allocates radio resources, a user control signal generation section 24 that generates a control signal for a user, a relay station control signal generation section 25 that generates a control signal related to relay information for a radio relay station apparatus, a baseband signal generation section 26 that generates a baseband signal including a control signal and user data, an RF signal generation section 27 that generates an RF signal by converting the baseband signal into a radio frequency signal, and a relay information generation section 28 that generates relay information that determines whether or not a mobile terminal apparatus performs relay transmission.

The uplink channel state measurement section 21 measures the uplink channel state using a reference signal transmitted from the mobile terminal apparatus. For this reference signal, in the LTE system, a sounding reference signal (SRS: Sounding Reference Signal) is used. Note that the channel state refers to the instantaneous channel gain of a frequency block (i) by fading among a mobile terminal apparatus, a radio relay station apparatus and a radio base station apparatus. The uplink channel state measurement section 21 outputs information about the uplink channel state to the scheduling section 23.

The uplink control signal receiving section 22 receives an uplink control signal from each mobile terminal apparatus. The control signal includes, for example path loss, scheduling request (SR), the amount to show downlink reception quality (CQI: Channel Quality Indicator), and so on. The uplink control signal receiving section 22 outputs the uplink control signal to the scheduling section 23.

The relay information generation section 28 generates, on a per user basis, relay information as to whether the mobile terminal apparatus performs relay transmission, based on reception quality such as downlink CQI and/or uplink reception SINR. That is to say, the relay information generation section 28 determines, on a per user basis, relay information as to whether or not the mobile terminal apparatus performs relay transmission. The relay information is reported to the scheduling section 23, the user control signal generation section 24 and the relay station control signal generation section 25. Note that, when an uplink signal is not subject to relay transmission, it is not necessary to report relay information to the scheduling section 23.

The relay station control signal generation section 25 generates control signals related to relay information for radio relay station apparatus. Also, the relay station control signal generation section 25 controls the relay amplification factor upon relaying an uplink signal. That is to say, upon performing relay transmission, the relay station control signal generation section 25 controls the relay amplification factor upon relay transmission.

In this way, upon relay transmission, the relay station control signal generation section 25 determines the relay amplification factor upon relay transmission. The relay station control signal generation section 25 generates information about the relay amplification factor determined in this way, as a relay station control signal, and outputs this signal to the baseband signal generation section 26.

The scheduling section 23 performs scheduling and allocates uplink and downlink radio resources. For this scheduling method, there are the above three methods. That is to say, these are (1) the method of allocating downlink resources based on the instantaneous channel gain by fading between a mobile terminal apparatus and a radio relay station apparatus, (2) the method of allocating downlink resources based on the value of above equation 1, and (3) the method of performing downlink resource allocation based on the instantaneous channel gain by fading between a mobile terminal apparatus and a radio relay station apparatus in the first time slot, and performing downlink resource allocation based on the instantaneous channel gain by fading between the radio relay station apparatus and a radio base station apparatus in a second time slot. Upon performing the above scheduling, the scheduling section 23 uses the instantaneous channel gain of a frequency block (i) by fading that is measured in the uplink channel state measurement section 21, and the path loss that is reported from the mobile terminal apparatus. The scheduling section 23 outputs uplink scheduling information and/or downlink scheduling information to the user control signal generation section 24.

The user control signal generation section 24 generates control information to report to each mobile terminal apparatus. This control information at least includes uplink scheduling information/downlink scheduling information, and, if necessary, also includes relay information. The user control signal generation section 24 outputs the control signal to the baseband signal generation section 26.

The baseband signal generation section 26 generates various control information and user data to include in a downlink signal. The baseband signal generation section 26 outputs the generated baseband signal to the RF signal generation section 27. The RF signal generation section 27 converts the baseband signal into a transmission signal (RF signal) for radio transmission. In this way, a radio base station apparatus transmits relay information including the relay amplification factor to the radio relay station apparatus.

Here, for the transmission power control method, the following methods can be used.

(1) RS-TPC Method 1

In the first radio relay station apparatus power amplification factor control method (RS-TPC method 1), the power amplification factor in a radio relay station apparatus is controlled such that the received signal power density in a radio base station apparatus via a radio relay station apparatus of a mobile terminal apparatus having performed relay transmission becomes substantially the same as when the mobile terminal apparatus is present in the location of the radio relay station apparatus and does not perform relay transmission.

Assuming that the amplification factor is G, the signal power density of the mobile terminal apparatus as received in the radio base station apparatus via the radio relay station apparatus is as shown by equation 3.

$$\begin{matrix}{R}^{( relay )} = G + {P}^{( relay )} - {PL}_{UE - RS} - {PL}_{RS - BS} \\ = G + {T}^{( relay )} + {P}_{noise} - \\ ( 1 - {α}^{( relay )} ) {PL}_{UE - RS} - {PL}_{RS - BS}\end{matrix} \qquad ( Equation 3 )$$

On the other hand, if the mobile terminal apparatus that is present in the location of the radio relay station apparatus performs transmission without relay transmission, the received signal power density in the radio base station apparatus is as shown by equation 4.

R₁^{(no relay)}=T^{(no relay)}+Pₙₒᵢₛₑ−(2−α^{(no relay)})PL_{RS-BS} (Equation 4)

Consequently, to hold that R^{(relay)}=R₁^{(no relay)}, G is controlled by equation 5.

G=T^{(no relay)}−T^{(relay)}+(1+α^{(relay)})PL_{US-RS}+α^{(no relay)}PL_{RS-BS} (Equation 5)

(2) RS-TPC Method 2

In the second radio relay station apparatus power amplification factor control method (RS-TPC method 2), the power amplification factor in a radio relay station apparatus is controlled such that the received signal power density in a radio base station apparatus via a radio relay station apparatus of a mobile terminal apparatus having performed relay transmission becomes substantially the same as when transmission is performed without relay transmission.

In actuality, a mobile terminal apparatus to which relay transmission is applied does not perform relay transmission, the received signal power density at the radio base station apparatus is as shown by equation 6.

R₂^{(no relay)}=T^{(no relay)}+Pₙₒᵢₛₑ−(1−α^{(no relay)})PL_{UE-BS} (Equation 6)

Consequently, to hold R^{(relay)}=R₂^{(no relay)}, G is controlled by equation 7.

G=T^{(no relay)}−T^{(relay)}+(1−α^{(relay)})PL_{UE-RS}−(1−α^{(no relay)})PL_{UE-BS}+PL_{RS-BS} (Equation 7)

Such power amplification factor control for a radio relay station apparatus may be performed in the radio relay station apparatus or may be performed in a radio base station apparatus. Note that, when the radio relay station apparatus performs power amplification factor control, the parameters in equation 5 or equation 7 are acquired from the radio base station apparatus or from the mobile terminal apparatus, according to need. For example, path loss PL_{UE-BS} according to RS-TPC method 2 may be acquired by signaling from the radio base station apparatus or may be acquired from reporting from the mobile terminal apparatus. To be more specific, in the former example, the mobile terminal apparatus measures path loss PL_{UE-BS} and reports this directly or via the radio relay station apparatus, to the radio base station apparatus, and the radio base station apparatus reports the parameters including path loss PL_{UE-BS}, to radio relay station apparatus. In the latter example, the mobile terminal apparatus measures path loss PL_{UE-BS} and reports this to the radio relay station apparatus. The radio relay station apparatus controls the power amplification factor of the radio relay station apparatus, with information about other parameters reported from the radio base station apparatus. This series of reporting and control are performed periodically, or are performed as triggered by a command by a control signal from the radio base station apparatus or the radio relay station apparatus. Also, when α^{(no relay)} is 1, RS-TPC method 1 and RS-TPC method 2 are equivalent.

Next, evaluation of user throughput will be described to clarify the advantages of the present invention. Assuming uplink OFDMA (Orthogonal Frequency Division Multiple Access) to divide a 4.32 MHz bandwidth into 24 frequency blocks, 8 UEs (mobile terminal apparatuses), per cell, are arranged in random locations. In scheduling, the number of frequency blocks to allocate per UE is limited to 3.

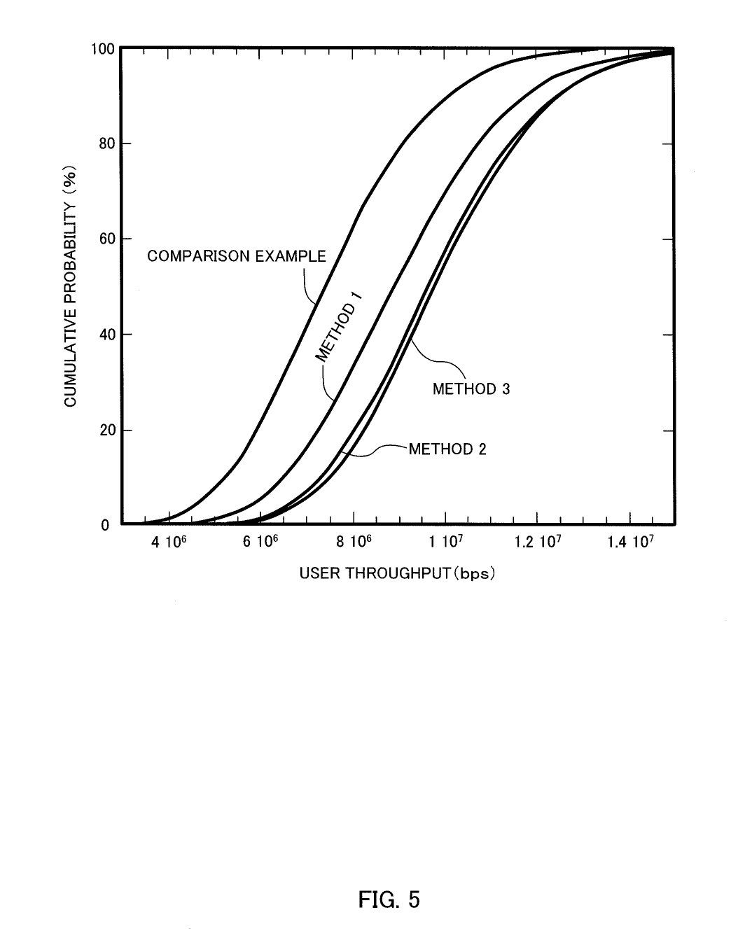

FIG. 5 illustrates cumulative distribution of user throughput. A case is illustrated where frequency blocks are allocated fixedly by round robin (comparison example). In the proportional-fair-type scheduling method upon adaptive AF-type relay transmission, to compare three scheduling methods, throughput increases in the order of the first method, second method, and third method. While the second method involves simple processes compared to the third method, the throughput to be achieved is substantially equal to the third method, and therefore the second method might be suitable for a system that calculates a metric based on a sounding reference signal of terminal transmission, as in LTE (Long Term Evolution).

In this way, according to the scheduling method of the present invention, the channel state is determined using the instantaneous channel gain of a frequency block (i) by path loss and fading and radio resources are allocated depending on this channel state, so that it is possible to improve user throughput.

The present invention is not limited to the above embodiments and can be implemented in various modifications. Although a case has been described with the above embodiment where path loss is measured in a mobile terminal apparatus and reported to a radio base station apparatus, the present invention is by no means limited to this, and path loss may be determined by other methods as well. The number of processing parts and the steps of processing in the above description may be implemented with appropriate changes, without departing from the scope of the present invention. Also, the elements illustrated in the drawings show functions, and each function block may be realized by hardware or may be realized by software. Besides, the present invention can be implemented with various changes, without departing from the scope of the present invention.

### INDUSTRIAL APPLICABILITY

The present invention is suitable for use in a radio base station apparatus and a scheduling method for an LTE system and its expanded system, LTE-Advanced.

The disclosure of Japanese Patent Application No. 2010-040304, filed on Feb. 25, 2010, including the specification, drawings and abstract, is incorporated herein by reference in its entirety.

1. A radio base station apparatus comprising:
a receiving section configured to receive a signal including a reference signal;
a channel state measurement section configured to measure an instantaneous channel gain by path loss and fading, among a mobile terminal apparatus, a radio relay station apparatus and a radio base station apparatus, with respect to an uplink, using the reference signal; and
a scheduling section configured to perform downlink resource allocation based on the instantaneous channel gain by path loss and fading.

2. The radio base station apparatus as defined in claim 1, wherein the scheduling section performs the downlink resource allocation based on the instantaneous channel gain by fading between the mobile terminal apparatus and the radio relay station apparatus.

3. The radio base station apparatus as defined in claim 1, wherein the scheduling section performs the downlink resource allocation based on the instantaneous channel gain by fading between the mobile terminal apparatus and the radio relay station apparatus in a first time slot, and performs the downlink resource allocation based on the instantaneous channel gain by fading between the radio relay station apparatus and the radio base station apparatus in a second time slot.

4. The radio base station apparatus as defined in claim 1, wherein the scheduling section performs the downlink resource allocation based on a value of following equation 1:
$$\begin{matrix}[ EQ . 1 ] & \\ {M}_{relay} ( i ) = \frac{\begin{matrix}{F}_{UE - BS} ( i ) {PL}_{UE - BS} + \\ {F}_{RS - BS} ( i ) {PL}_{RS - BS} {GF}_{UE - RS} ( i ) {PL}_{UE - RS}\end{matrix}}{{PL}_{UE - BS} + {PL}_{RS - BS} {GL}_{UE - RS}} & ( Equation 1 )\end{matrix}$$

5. A scheduling method comprising the steps of:
receiving a signal including a reference signal;
measuring an instantaneous channel gain by path loss and fading, among a mobile terminal apparatus, a radio relay station apparatus and a radio base station apparatus, with respect to an uplink, using the reference signal; and
performing downlink resource allocation based on the instantaneous channel gain by path loss and fading.

6. The scheduling method as defined in claim 5, wherein the downlink resource allocation is performed based on the instantaneous channel gain by fading between the mobile terminal apparatus and the radio relay station apparatus.

7. The scheduling method as defined in claim 5, wherein the downlink resource allocation is performed based on the instantaneous channel gain by fading between the mobile terminal apparatus and the radio relay station apparatus in a first time slot, and the downlink resource allocation is performed based on the instantaneous channel gain by fading between the radio relay station apparatus and the radio base station apparatus in a second time slot.

8. The scheduling method as defined in claim 5, wherein the downlink resource allocation is performed based on a value of following equation 1:
$$\begin{matrix}[ EQ . 2 ] & \\ {M}_{relay} ( i ) = \frac{\begin{matrix}{F}_{UE - BS} ( i ) {PL}_{UE - BS} + \\ {F}_{RS - BS} ( i ) {PL}_{RS - BS} {GF}_{UE - RS} ( i ) {PL}_{UE - RS}\end{matrix}}{{PL}_{UE - BS} + {PL}_{RS - BS} {GL}_{UE - RS}} & ( Equation 1 )\end{matrix}$$
